(19) United States
(12) Patent Application Publication
(10) Pub. No.: US 2010/0164688 A1
(43) Pub. Date: Jul. 1, 2010

(54) AUXILIARY DEVICE FOR IMPLANTABLE UNITS

(75) Inventor: Sudipto CHAKRABORTY, Richardson, TX (US)

Correspondence Address: TEXAS INSTRUMENTS INCORPORATED, P O BOX 655474, M/S 3999, DALLAS, TX, 75265, US

(73) Assignee: TEXAS INSTRUMENTS INCORPORATED, Dallas, TX (US)

(21) Appl. No.: 12/347,652

(22) Filed: Dec. 31, 2008

(51) Int. Cl. H04Q 5/22

(52) U.S. Cl. 340/10.1

(57) ABSTRACT

In at least some embodiments, an auxiliary device compatible with a biomedical implantable comprises a first transceiver and a controller coupled to the first transceiver. If the first transceiver receives a wireless data signal from an implantable unit, the controller generates a corresponding data signal for transmission to a wireless network. The corresponding data signal has at least one of a higher power level and a higher frequency band compared to the wireless data signal.

### BACKGROUND

Implantable biomedical devices are used to provide therapeutic functions, monitoring functions, or other functions. Examples of such implantable devices include drug infusion pumps, neurostimulators, cardioverters, cardiac pacemakers, defibrillators, and cochlear implants. In general, the function of an implantable device will require some energy. However, powering and communicating with implantable devices is a significant challenge.

As an example, using electrical wires to transfer power/signals to an implanted device increases a patient's risk of infection. Meanwhile, batteries often contain toxic materials and increase the size of the implanted device. Further, batteries eventually must be replaced if the lifetime of the battery is less than the desired lifetime of the implanted device. In such case, removal of an implanted device for battery replacement would be necessary. Wireless signals could be used to power or communicate with an implanted device. However, exposure to high energy wireless signals represents a potential danger for patients as well.

### SUMMARY

In at least some embodiments, an auxiliary device compatible with a biomedical implantable unit comprises a first transceiver and a controller coupled to the first transceiver. If the first transceiver receives a wireless data signal from an implantable unit, the controller generates a corresponding data signal for transmission to a wireless network. The corresponding data signal has at least one of a higher power level and a higher frequency band compared to the wireless data signal from the implantable unit.

In at least some embodiments, a system comprises an implantable unit and an auxiliary device in communication with the implantable unit. The system further comprises a wireless network in communication with the auxiliary device. The implantable unit transmits wireless signals to the auxiliary device, the wireless signals having a first range. The auxiliary device transmits corresponding wireless signals to the wireless network, the corresponding wireless signals having a second range that is greater than the first range.

In at least some embodiments, a method for an implantable unit and an auxiliary device comprises receiving, by the auxiliary device, a wireless data signal from the implantable unit. The method further comprises generating, by the auxiliary device, a corresponding data signal for transmission to a wireless network, wherein the corresponding data signal has at least one of a higher power level and a higher frequency band compared to the wireless data signal.

### BRIEF DESCRIPTION OF THE DRAWINGS

For a detailed description of various embodiments of the invention, reference will now be made to the accompanying drawings in which:

FIG. 1 illustrates a system in accordance with various embodiments;

FIG. 2 illustrates additional details of the system of FIG. 1 in accordance with various embodiments;

FIG. 3 illustrates an implantable unit in accordance with various embodiments; and

FIG. 4 illustrates a method in accordance with various embodiments.

### NOTATION AND NOMENCLATURE

Certain terms are used throughout the following description and claims to refer to particular system components. As one skilled in the art will appreciate, computer companies may refer to a component by different names. This document does not intend to distinguish between components that differ in name but not function. In the following discussion and in the claims, the terms “including” and “comprising” are used in an open-ended fashion, and thus should be interpreted to mean “including, but not limited to . . . .” Also, the term “couple” or “couples” is intended to mean either an indirect or direct electrical connection. Thus, if a first device couples to a second device, that connection may be through a direct electrical connection, or through an indirect electrical connection via other devices and connections. The term “system” refers to a collection of two or more hardware and/or software components, and may be used to refer to an electronic device or devices or a sub-system thereof. Further, the term “software” includes any executable code capable of running on a processor, regardless of the media used to store the software. Thus, code stored in non-volatile memory, and sometimes referred to as “embedded firmware,” is included within the definition of software.

### DETAILED DESCRIPTION

While the invention is susceptible to various modifications and alternative forms, specific embodiments thereof are shown by way of example in the drawings and will herein be described in detail. It should be understood, however, that the drawings and detailed description thereto are not intended to limit the invention to the particular form disclosed, but on the contrary, the intention is to cover all modifications, equivalents and alternatives falling within the spirit and scope of the present invention as defined by the appended claims.

Embodiments of the disclosure provide an auxiliary device to assist with the power/communication needs of one or more biomedical implantable units. In accordance with some embodiments, each auxiliary device extends the communication range of at least one implantable unit. An auxiliary device may extend the communication range of an implantable unit by, for example, increasing the power level of signals transmitted from the implantable unit, improving the signal quality (reducing noise or increasing the signal-to-noise ratio (SNR)), or increasing the base frequency. The auxiliary device's range extension operation may vary, for example, to comply with communication frequency plans/restrictions of different countries.

In at least some embodiments, the auxiliary device is positioned close to an implanted unit and wirelessly transfers power and/or data signals to the implanted unit. For example, the auxiliary device could be attached to the patient's skin or clothing. Alternatively, the auxiliary device could be positioned within a couple of meters of the patient. In either case, the close proximity of the auxiliary device to the implanted unit enables communication signals to or from the implanted unit to have less than a predetermined energy level (e.g., a level determined to be detrimental to a patient). Similarly, the close proximity of the auxiliary device to the implanted unit enables the auxiliary device to transmit power signals to the implanted unit without exposing the patient to wires or to high energy wireless signals (i.e., signals having a frequency level and/or a power level greater than a predetermined maximum).

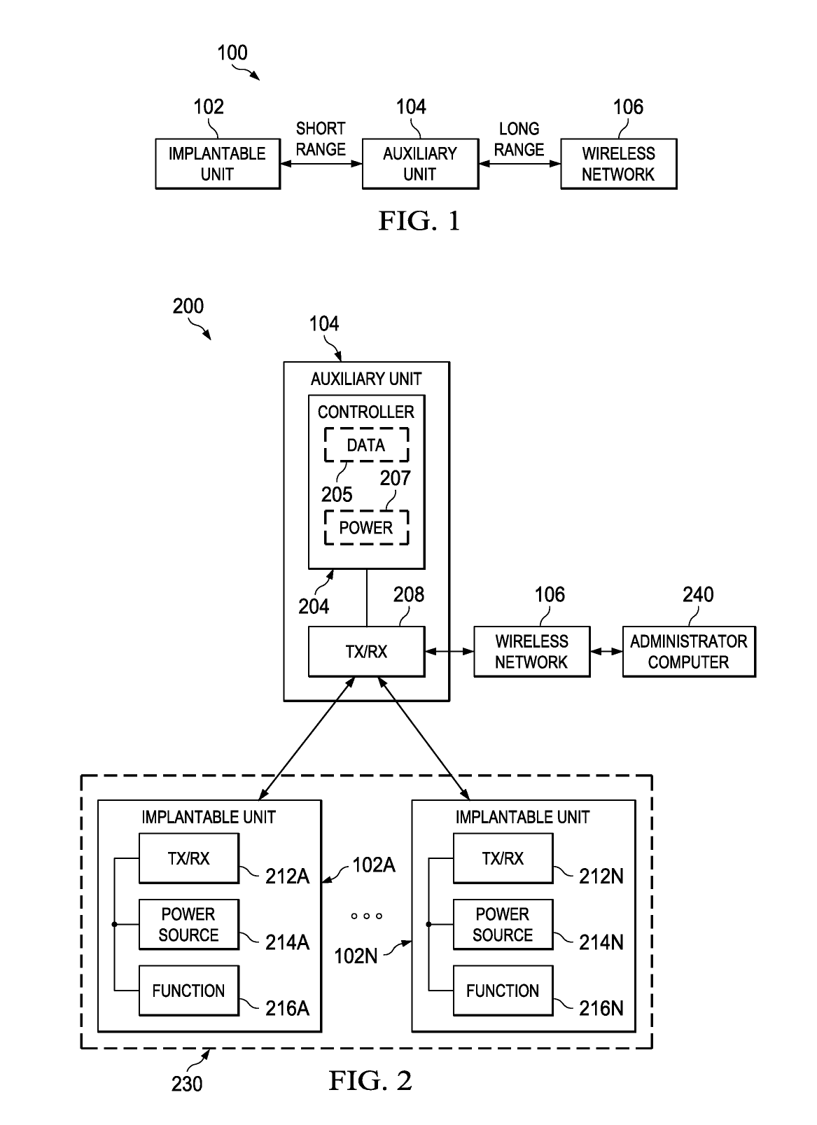

FIG. 1 illustrates a system 100 in accordance with embodiments. In FIG. 1, an auxiliary device 104 functions as an intermediary communication interface between an implantable unit 102 and a wireless network 106. As an example, upon receiving wireless data signals from the implantable unit 102, the auxiliary device 104 provides corresponding data signals for transmission to the wireless network 106.

In some embodiments, the auxiliary device 104 provides the corresponding data signals by modifying the received signals for transmission to the wireless network 106. For example, modifying the received signals may involve increasing the power level and/or increasing the frequency band of the received signals for transmission to the wireless network 106. Additionally, modifying the received signal may involve applying error correction coding and/or encryption techniques to the received signals to improve the integrity and privacy of the data content transmitted to the wireless network 106.

In alternative embodiments, the auxiliary device 104 processes the wireless data signals received from the implantable unit 102 and generates new signals based on the data content extracted from the received signals. The new signals can subsequently be transmitted to the wireless network 106. Similar to the modified signals discussed previously, the new signals may have an increased power level and/or an increased frequency band compared to the data signals received from the implantable unit 102. Additionally, the auxiliary device 104 may apply error correction coding and/or encryption techniques to the new signals to improve the integrity and privacy of the data content transmitted to the wireless network 106.

In accordance with embodiments, the implantable unit 102 communicates with the auxiliary device 104 based on short-range wireless signals, while the auxiliary device 104 communicates with the wireless network 106 based on long-range wireless signals. As an example, the short-range wireless signals transmitted from the implantable unit 102 may have a range of approximately 2 meters and the long-range wireless signals transmitted from the auxiliary device 104 may have a range of 10 meters or more.

In addition to data content being transmitted from the implantable unit 102 to the wireless network 106 via the auxiliary device 104 as described previously, other communications are possible. For example, the wireless network 106 may transmit data/signals to the implantable unit 102 via the auxiliary device 104. In such case, the wireless network 106 communicates with the auxiliary device 104 based on long-range wireless signals and the auxiliary device 104 subsequently communicates with the implantable unit 102 based on short-range wireless signals. In other words, the auxiliary device 104 converts long-range wireless signals received from the wireless network 106 to short-range wireless signals or generates short-range wireless signals based on long-range wireless signals received from the wireless network 106.

Alternatively, the wireless network 106 may transmit data directly to the implantable unit 102 (i.e., the implantable unit 102 receives but does not generate long-range wireless signals). In such case, the auxiliary device 102 would still act as an intermediary (e.g., a range extender) for communications from the implantable unit 102 to the wireless network 106.

In at least some embodiments, the auxiliary device 104 performs functions in addition to relaying data between the implantable device 102 and the wireless network 106. For example, the auxiliary device 104 may transmit its own requests/commands to the implantable unit 102 and store/process responses to those request/commands. The auxiliary device 104 also may store/process information received from the implantable unit 102, where the received information is not in response to requests/commands from the auxiliary device 104 (i.e., the implantable unit 102 may be configured to transmit information without being prompted by the auxiliary device 104). Further, the auxiliary device 104 may provide power to implantable unit 102 in the form of short-range wireless signals.

FIG. 2 illustrates additional details of the system 100 of FIG. 1 in accordance with embodiments. In FIG. 2, a plurality of implantable units 102A-102N are able to communicate with the wireless network 106 via the auxiliary device 104. As shown, each of the implantable units 102A-102N comprises a transceiver (TX/RX) 212, a power source 214 and a function block 216, which are coupled to each other. More specifically, the implantable unit 102A comprises transceiver 212A, power source 214A and function block 216A. Similarly, the implantable unit 102B comprises transceiver 212B, power source 214B and function block 216B, and so on. Is should be understood that each of the implantable units 102 may have the same types of components (transceivers, power sources, and function blocks) or different types of components.

In operation, each power source 214 provides power to components of its corresponding transceiver 212 and function block 216. For instance, using the implantable unit 102A as an example, the power source 214A would power components of the transceiver 212A and the function block 216A. Also, data may be passed between each corresponding transceiver 212, power source 214 and function block 216. For instance, using the implantable unit 102A as an example, data may be passed between the transceiver 212A, the power source 214A and the function block 216A.

In at least some embodiments, each transceiver 212 comprises at least one antenna and logic to handle incoming or outgoing signals in accordance with known or later developed wireless protocols. Each power source 214 is preferably rechargeable and may comprise, for example, a battery and/or a capacitor. Each function block 216 is configured to perform at least one biomedical function (e.g., related to drug infusion pumps, neurostimulators, cardioverters, cardiac pacemakers, defibrillators, cochlear implants, or other devices) and/or a monitoring function (e.g., monitoring the biomedical function, body conditions, or power status).

In at least some embodiments, the function blocks 216 are responsive to wireless signals (e.g., requests for information, commands, or other prompts) received from the auxiliary device 104 and/or the wireless network 106. Additionally or alternatively, the function blocks 216 are configured to periodically and automatically transmit predetermined information (e.g., updates on monitored conditions) to the auxiliary device 104 and/or the wireless network 106.

As shown in FIG. 2, the auxiliary device 104 comprises a controller 204 coupled to a transceiver 208. It should be appreciated that the controller 204 may correspond to at least one of a variety of semiconductor devices such as, for example, a microprocessor, a microcontroller, a central processor unit (CPU), a main processing unit (MPU), a digital signal processor (DSP), an advanced reduced instruction set computing (RISC) machine, an (ARM) processor, an application specific integrated circuit (ASIC), a field programmable gate array (FPGA). In at least some embodiments, the controller 204 includes or has access to sufficient memory to perform a set of predetermined operations. In general, the functionality of the controller 204 may be based on hardware, firmware, software, or a combination thereof.

In accordance with at least some embodiments, the controller 204 enables the auxiliary device 104 to perform data operations 205 and power operations 207 to assist the implantable units 102. The implantable units 102 preferably perform core biomedical or monitoring functions that can only be performed by implanted units. Also, the implantable units 102 can perform short-range (low-power) communications. Meanwhile, the auxiliary device 104 preferably augments the capability of the implantable units 102 using the data operations 205 and/or the power operations 207. In accordance with some embodiments, the data operations 205 of the auxiliary device 104 extend or otherwise improve the communication abilities of the implantable units 102.

The data operations 205, for example, may comprise modifying signals received from implantable units 102 for transmission to the wireless network 106. As previously mentioned, modifying signals may involve increasing the power level, increasing the frequency band, applying error correction coding and/or applying encryption to signals received from the implantable units 102. Additionally or alternatively, the data operations 205 may comprise processing signals received from the implantable units 102 and generating new signals based on the data content extracted from the received signals. The new signals can subsequently be transmitted to the wireless network 106 and may have an increased power level and/or an increased frequency band compared to the data signals received from the implantable units 102. Additionally, the data operations 205 may comprise applying error correction coding and/or encryption techniques to the new signals to improve the integrity and privacy of the data content transmitted to the wireless network 106.

The data operations 205 also may comprise converting long-range wireless signals received from the wireless network 106 to short-range wireless signals for one or more implantable units 102. The short-range wireless signals may differ from the long-range wireless signal with regard to power level, frequency band, error correction coding, encryption technique, or other features.

In some embodiments, the wireless network 106 is able to transmit data directly to the implantable units 102. In such embodiments, the auxiliary device 104 still acts as an intermediary for communications from the implantable units 102 to the wireless network 106 (i.e., the implantable units 102 receive, but do not generate long-range wireless signals).

The power operations 207 extend or otherwise improve the battery life of the implantable units 102. In accordance with embodiments, the power operations 207 cause a wireless charge signal to be transmitted to at least one of the implantable devices 102. The implantable units 102 use the wireless charge signal to recharge (at least partially) an onboard capacitor and/or battery.

In performing the data operations 205 and the power operations 207, the controller 204 sends signals to and receives signals from the transceiver 208. In accordance with some embodiments, the transceiver 208 receives digitized data (e.g., related to the data operations 205 and/or the power operations 207) as directed by the controller 204 and encodes the data for transmission. In accordance with embodiments, the transceiver 208 comprises circuitry which receives encoded data and modulates the encoded data by a carrier signal having one or more desired transmit frequencies. If multiple implantable units 102 are present, the transceiver 208 may employ an addressing scheme or otherwise prepares signals for reception by different implantable units 102.

In FIG. 2, the wireless network 106 receives signals from the auxiliary device 104 and forwards the data content from these signals to an administrator computer 240. The administrator computer 240 processes and/or stores the data content. For example, the data content can be processed to analyze body conditions and/or implantable unit conditions. In at least some embodiments, the administrator computer 240 is able to present information (e.g., information related to the analysis) to an administrator via a suitable graphic user interface (e.g., a liquid crystal display). Based on the information provided by the implantable units 102 or based on other criteria, the administrator computer 240 may also provide various commands/requests to the implantable units 102 (e.g., to vary the operation of the implantable units 102 or to request additional information).

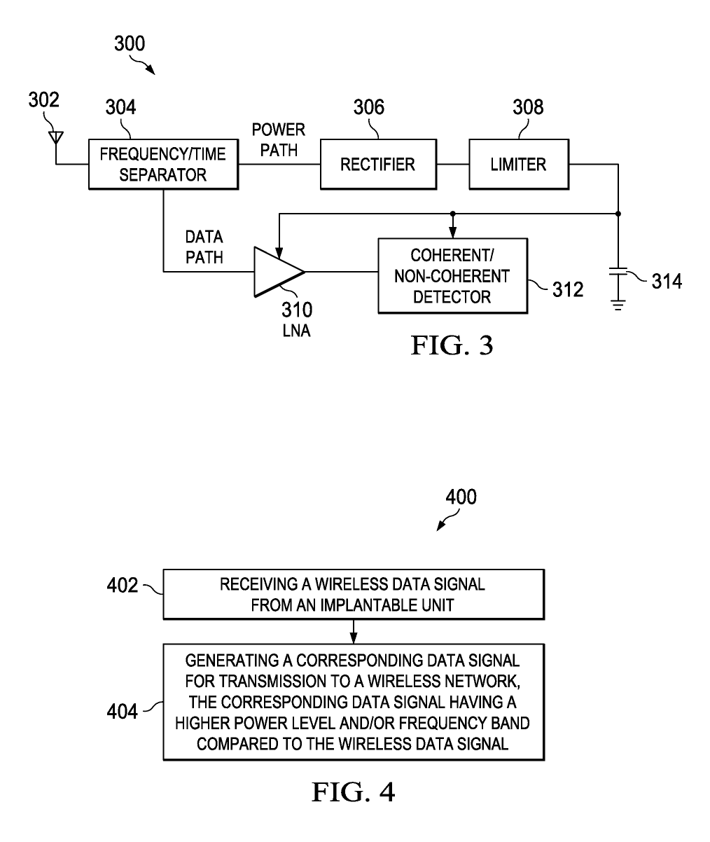

FIG. 3 illustrates an implantable unit 300 in accordance with embodiments. The implantable unit 300 may correspond to the implantable units 102 described for FIGS. 1 and 2. As shown, the implantable unit 300 comprises an antenna 302 coupled to a frequency/time separator 304. The frequency/time separator 304 separates received signals to either a power path or a data path according to frequency parameters and/or time parameters. As an example of using frequency parameters, the frequency/time separator 304 may direct received signals having a first frequency band to the power path and direct received signals having a second frequency band to the data path. In accordance with some embodiments, the first frequency band may be at approximately 900 MHz and the second frequency band is at approximately 400 MHz. However, embodiments are not limited to any particular frequency bands.

As an example of using time parameters, the frequency/time separator 304 may selectively direct received signals to the power path or to the data path according to a predetermined time pattern or packet count. In some embodiments, the predetermined time pattern or packet count is synchronized with the data operations 205 and the power operations 207 of the auxiliary unit 104.

As shown in FIG. 3, signals directed to the power path pass through a rectifier 306 and a limiter 308. The rectifier 306 changes alternating current (AC) to direct current (DC) and the limiter 308 ensures the output from the rectifier 306 does not exceed a predetermined voltage level. The output from the limiter 308 charges a capacitor 314, which can be used to power other components of the implantable unit 300.

In at least some embodiments, signals directed to the data path pass through a low-noise amplifier (LNA) 310 and a coherent or non-coherent detector 312 for demodulating data signals. As shown, the low-noise amplifier 310 and the coherent or non-coherent detector 312 are coupled to and may receive power from the capacitor 314. It should be understood that the components shown for the implantable unit 300 may be separate from or part of a transceiver, power source and/or function block (e.g., the transceivers 212, the power sources 214 and/or the functions 216 described previously).

FIG. 4 illustrates a method 400 in accordance with embodiments. As shown, the method 400 comprises receiving a wireless data signal from an implantable unit (block 402). At block 404, a corresponding data signal is generated for transmission to a wireless network, the corresponding data signal having a higher power level and/or frequency band compared to the wireless data signal.

The above discussion is meant to be illustrative of the principles and various embodiments of the present invention. Numerous other variations and modifications will become apparent to those skilled in the art once the above disclosure is fully appreciated. It is intended that the following claims be interpreted to embrace all such variations and modifications.

What is claimed is:

1. An auxiliary device compatible with a biomedical implantable unit, comprising:
a first transceiver;
a controller coupled to the first transceiver,
wherein, if the first transceiver receives a wireless data signal from an implantable unit, the controller generates a corresponding data signal for transmission to a wireless network,
wherein the corresponding data signal has at least one of a higher power level and a higher frequency band compared to the wireless data signal.

2. The auxiliary device of claim 1 further comprising a second transceiver, the second transceiver transmits the corresponding data signal to the wireless network.

3. The auxiliary device of claim 1 wherein the controller selectively generates a power signal and a data signal to be transmitted to the implantable unit.

4. The auxiliary device of claim 3 wherein the power signal and the data signal are transmitted to the implantable device over a single frequency band using time division multiplexing.

5. The auxiliary device of claim 3 wherein the power signal and the data signal are transmitted to the implantable device over different frequency bands using frequency division multiplexing.

6. The auxiliary device of claim 1 wherein the first transceiver is configured to transmit and receive wireless data signals at a carrier frequency of approximately 400 MHz.

7. The auxiliary device of claim 1 wherein a range of the wireless data signal is less than 2 meters.

8. The auxiliary device of claim 1 further comprising a housing for the transceiver and the controller, wherein the housing has at least one surface adapted for attachment to skin.

9. A system, comprising:
an implantable unit;
an auxiliary device in communication with the implantable unit; and
a wireless network in communication with the auxiliary device,
wherein the implantable unit transmits wireless signals to the auxiliary device, the wireless signals having a first range, and
wherein the auxiliary device transmits corresponding wireless signals to the wireless network, the corresponding wireless signals having a second range that is greater than the first range.

10. The system of claim 9 wherein the implantable unit comprises a frequency separator coupled to an antenna, wherein the frequency separator directs wireless signals received at a first carrier frequency to a power path and directs wireless signals received at a second carrier frequency to a data path.

11. The system of claim 10 wherein the first carrier frequency is approximately 900 MHz and the second carrier frequency is approximately 400 MHz.

12. The system of claim 9 wherein the implantable unit comprises a time separator coupled to an antenna, wherein the time separator selectively divides wireless signals received at a predetermined carrier frequency into a first part for a data path and into a second part for a power path.

13. The system of claim 12 wherein the predetermined carrier frequency is approximately 400 MHz.

14. The system of claim 9 wherein the auxiliary device comprises a controller and a transceiver coupled to the controller, wherein the controller provides at least one power operation to assist the implantable unit.

15. The system of claim 14 wherein the power operation comprises selectively generating a wireless power signal compatible with the implantable unit.

16. The system of claim 14 wherein the auxiliary device comprises a controller and a transceiver coupled to the controller, wherein the controller provides at least one data operation to assist the implantable unit.

17. The system of claim 16 wherein the data operation comprises converting wireless signals received from the implantable unit into corresponding wireless signals compatible with the wireless network.

18. A method for an implantable unit and an auxiliary device, comprising:
receiving, by the auxiliary device, a wireless data signal from the implantable unit;
generating, by the auxiliary device, a corresponding data signal for transmission to a wireless network,
wherein the corresponding data signal has at least one of a higher power level and a higher frequency band compared to the wireless data signal.

19. The method of claim 18 further comprising,
selectively transmitting, by the auxiliary device, a power signal and a data signal to the implantable unit;
distributing, by the implantable unit, the power signal to a power path and the data signal to a data path of the implantable unit,
wherein said distributing is based on time-division multiplexing.

20. The method of claim 18 further comprising,
selectively transmitting, by the auxiliary device, a power signal and a data signal to the implantable unit;
distributing, by the implantable unit, the power signal to a power path and the data signal to a data path of the implantable unit,
wherein said distributing is based on frequency-division multiplexing.
